(19) United States
(12) Patent Application Publication
(10) Pub. No.: US 2021/0198843 A1
(43) Pub. Date: Jul. 1, 2021

(54) IMPROVEMENTS IN AND RELATING TO GARMENT REVIVAL

(71) Applicant: Conopco, Inc., d/b/a UNILEVER, Englewood Cliffs, NJ (US)

(72) Inventors: Christopher Boardman, Denbigh (GB); Julie Cullen, Wallasey (GB); Giovanni Francesco Unali, Merseyside (GB)

(21) Appl. No.: 16/754,886

(22) PCT Filed: Nov. 27, 2018
(86) PCT No.: PCT/EP2018/082740

§ 371 Date: Apr. 9, 2020

(30) Foreign Application Priority Data
Oct. 13, 2017 (EP) 17196275.6
Nov. 29, 2017 (EP) 17204518.9
Nov. 29, 2017 (EP) 17204524.7

(51) Int. Cl. D06M 23/06; D06F 87/00; D06M 15/643; D06M 23/12; D06M 23/14

(52) U.S. Cl. CPC D06M 23/06; D06F 87/00; D06M 2200/20; D06M 23/12; D06M 23/14; D06M 15/643

(57) ABSTRACT

The present invention is concerned with a garment revival product comprising: a garment reviving composition; and a hand-held spray device which is manually operable to produce a spray of said composition; said composition comprising one or more setting polymers.

The present invention relates to garment revival in between main washes and in particular but not exclusively a garment revival spray product and method use to revive garments in between main washes.

So called ‘refresh’ products have been proposed previously, for example hand-held sprayable “air fresheners” or carpet and upholstery refreshers comprising odour-masking compounds and/or a perfumes. Such compositions are sprayed onto the carpet/upholstery surface or into the air in order to refresh by neutralising and/or masking unpleasant odours. There are also ‘refresh’ spray products which perfume garments with the intent of prolonging their acceptable use between washes.

However, despite the presence of such products on the market, consumer acceptance of an intermediate ‘refresh’ spray to prolong garment use between washes is low. The potential savings in both water/energy from refresh products are not being realised.

One problem is that certain items which are potentially suitable for an intermediate refresh due to low stain/soiling/odour, (such as uniforms, smart shirts or trousers) have specific visual qualities cueing cleanliness and these are not improved by odour masking/perfumes. So, for example, a smart shirt may be worn briefly and after it is unstained with low/no malodour but it still appears ‘worn’ even if refreshed by a odour masking/perfume. A key visual quality of the garment is its structure, more particularly its rigidity which may impart a particular three dimensional shape and/or also its signature creases, in particular ironed creases such as the elongate creases running the length of a sleeve or a trouser leg. Either/both of these features can be lost by wear such that the garment appears baggy or stretched. The use of conventional aqueous sprays does not alleviate this problem, and such use may actually exacerbate bagginess/stretching.

Refresh perfume sprays do not provide consumers with any confidence about re-wearing (without washing) because they feel garment does not visually convey to others a clean, just-washed image. It is often the perception by other people in visual appearance, rather than their own opinion that matters with smart clothing. As such, this can be the main driver to avoid intermediate treatments and opting, instead for a washing process.

It is therefore an object of the present invention to provide an improved garment treatment product for use between washes.

In a first aspect the present invention provides a garment revival product comprising: a garment revival composition; and a hand-held spray device which is manually operable to produce a spray of said composition, said composition comprising one or more fabric setting components.

a second aspect the present invention provides a garment revival system using a garment revival delivery device for delivering a garment revival composition, said composition comprising one or more fabric setting components. The delivery device may be a hand-held spray device, manually operable to produce a spray of said composition.

In a further aspect, the present invention provides a garment revival method using a garment revival product comprising: a garment revival composition comprising a fabric setting component and a hand-held spray device which is manually operable to produce a spray of said composition, said method comprising the step of spraying said garment by operating the spray device so as to direct the spray output of the device on to the garment.

In a further aspect the present invention provides a use of a garment revival product to apply a garment setting component to a garment so as to revive the garment structure.

In a further aspect the present invention provides use of a fabric setting component to revive the garment structure.

As used herein “aerosol” means a colloid of either dry particles or liquid droplets (of the garment revival composition) suspended in air. Liquid droplets are of particular interest. An aerosol may be produced using a propellant (in which case the spray device may be referred to by the informal term “aerosol-type device) or without a propellant. As noted elsewhere, the present invention is particularly concerned with non-propellant devices.

The setting components advantageously reset the mechanical properties to provide a just washed rigidity. With the arrangement of the invention, the consumer can improve the key visual and tactile features that cue cleanliness: three-dimensional shape/form and specific signature creases which are seen and felt. The applicant has found that such structural qualities cue a ‘just washed and ironed’ cleanliness level which is most advantageous for e.g. pleated skirts, school uniforms, smart trousers. Observers actually infer cleanliness from signature creases and/or garment structure. These shape features, which are inevitably lost by wear, can be re-created simply by spraying without washing and/or hot ironing. Furthermore by providing a spray that is adapted to consumer preferences for cleanliness cues and tailored to structural garment revival such that consumer confidence is boosted, use of the product will increase, and preferably become habitual, thereby reducing the frequency of washes. And so a reduction in the use of water, cleaning actives and energy can be achieved. This is a valuable contribution especially in view of the large volumes of water used in washing machines. As such, the presence of fabric setting components transforms a product from a refresh product which simply freshens a fabric to a fabric revival product, which revives the look and feel of just washed fabric.

Preferably, the composition further comprises an anti-wrinkle agent.

Although the inclusion of both anti-wrinkle agent and a fabric setting component may seem counter-intuitive, this has the effect of both removing creases imparted by wearing and then allowing the consumer to reset those desirable creases. The ability to reset visually the garment to a ‘just washed and ironed’ state further improves the consumer's confidence in re-wear without washing.

Preferably the composition is an aqueous composition.

Preferably, the composition comprises a anti-malodour agent.

Preferably, the composition further comprises a perfume.

With the invention the applicant has found further benefits in that ambient pressing of desired creases can be obtained. The avoidance of heat (e.g. by avoiding use of hot irons) and the use of ambient temperatures protects components such as perfumes as herein described.

Accordingly the method may further comprise the step of manually pressing the garment. Preferably this step is at ambient/room temperature so without the addition of heat. Pressing may be entirely manual i.e. using only the user's hands or with a pressing implement. Hot ironing is not required but a cold pressing implement is not excluded. Pressing may be simultaneous with spraying or may follow after spraying.

The method may comprise the step of hanging the garment from a frame, such as a coat hanger, and spraying in this position.

The method may further comprise the step of spraying non-creased, curved folds to impart volume to a garment.

The method may further comprise the step of spraying the garment at multiple angles thereby rotating the spray device about at least one orthogonal axis, preferably two axis, more preferably three axis, and spraying the garment for imparting a three dimensional structural form to the garment. This may be used to increase the volume of a skirt or blouse or trousers for instance, where a ‘box-look’ is required or for giving volume to flared trousers.

The method may comprise the step of pressing the garment, said garment supported on a support surface. Said support surface may be a level, flat surface. Said support surface may be a bed or table top.

The method may include the step of pressing a garment so as to create one or more creases therein. Said creases may comprise elongate creases running the length of an arm or leg of a garment.

The invention improves the confidence of the wearer that others will view the garment as clean. This is often as important to the consumer as their own opinion. Thus, where is has not been possible to wash a shirt after wearing, it can be revived without any washing or heated appliances, quickly and conveniently.

Further preferred features of the invention are provided below.

### Spray Device

Spray Mechanism

Suitably the spray device is a manually operable spray device in the sense that the spray mechanism is manually operable to discharge a dose of said composition from the nozzle.

Suitably the spray mechanism is operated by an actuator. The actuator can be a push actuator or a pull actuator. The actuator may comprise a trigger.

Said spray mechanism may comprise a hand-operable pump.

Optionally, said pump is one of: a positive displacement pump; a self-priming pump; a reciprocating pump.

Spray devices may include trigger sprays, continuous/semi-continuous sprays, finger pump sprays, vibrating mesh device output sprays.

Pressurised spray devices are preferred, but more preferably the spray device is operable without the use of a propellant. Indeed, propellant-free spray devices are preferred. This allows the spray to maintain the integrity and purity of the product, uncontaminated with propellant and is preferably environmentally.

Pressurising improves spray duration and velocity. Preferably the spray device is pressurised by a gas chamber, separate from the reservoir containing the composition. The gas is preferably air or nitrogen.

The spray device may comprise an outer container containing the composition and a pressurizing agent, wherein the composition is segregated from the pressurizing agent by containment (preferably hermetically sealed) in a flexible pouch. This which maintains complete formulation integrity so that only pure (i.e. excludes pressurising agent) composition is dispensed. Preferred systems are the so-called tag-in-can′ (or BOV, bag-on-valve technology).

The outer container is preferably rigid sufficient to contain the pressurised agent. The pressurised agent is preferably a gas such as air or nitrogen. The flexible pouch is preferably a laminate pouch. The flexible pouch is suitably fluidly connected to a nozzle. With such a spray device, compressed air or nitrogen can be charged into the outer container, and an aerosol valve with the bag attached is crimped onto the container. The formulation is forced through the aerosol valve stem to fill the bag. Finally, the actuator and cap are put in place. One advantage is with such a spray device is that it can provide 360-degree dispensing for spraying of an article. This is especially useful for the method of spraying for imparting volume, structural features as above.

The spray device may comprise piston barrier mechanism, for example EarthSafe by Crown Holdings.

Preferred examples include the so-called ‘plastic aerosols’. SprayPET pack by Plastipak. The aerosol spray device may comprise a bag-on-valve dispensing mechanism. A preferred dispensing mechanism is the Power Pouch by Power Container Corporation, US.

Preferably the spray device is plastic. Preferably the plastic comprise PET.

Alternatively or additionally, the plastic material is selected from the group comprising, polyethylene (PE), poly(ethylene terephthalate) (PET), high-density polyethylene (HDPE), low-density polyethylene (LDPE); polypropylene (PP), poly(vinyl chloride) (PVC), polystyrene (PS), polycarbonate (PC), and polyamides (PA). and mixtures thereof.

Preferably the spray device comprises a biodegradable plastic material.

Preferably the spray device comprises a recycled plastic material, and this which may be reclaimed polymer e.g. reclaimed polypropylene. Suitably the reclaimed polypropylene comprises at least 50% and more preferably at least 80% and more preferably at least 95% isotactic polypropylene base resin.

As used herein, “reclaimed polymer” or “reclaimed polypropylene” refers respectively to a polymer or polypropylene used for a previous purpose and then recovered for further processing.

As used herein, the term “base resin” refers to a polymeric resin used to form an article that has not yet been combined with an additive or additive mixture (i.e. colorant masterbatch) that may be used during the manufacture of the article. The base resin is often combined with an additive or additive mixture simultaneously during the manufacture of an article.

Preferably the plastic material is comprises a bio-based plastic or bioplastic, which may be suitably derived from biological sources e.g. biomass. Exemplary bioplastics comprise polyethylene furanoate, starch-based fabrics which may be blended with biodegradable polyesters e.g. starch/polylactic acid, starch/polycaprolactone or starch/Ecoflex™ (polybutylene adipate-co-terephthalate produced by BASF) blends; cellulose-based plastics, protein-based plastics, aliphatic biopolyesters polyhydroxyalkanoates (PHAs) like the poly-3-hydroxybutyrate (PHB), polyhydroxyvalerate (PHV) and polyhydroxyhexanoate (PHH), polyamides e.g. PA 11 is a biopolymer derived from natural oil: Rilsan B, commercialized by Arkema; PA12 and PA 410; bioderived polyethylene derived from ethanol, which has been produced by fermentation of agricultural feedstocks such as sugar cane or corn. BioPET plastic may comprise bio-based MEG (monoethylene glycol).

Preferably any flexible parts (such as pouches contained within outer containers as herein described) comprise laminated, where the laminate may contain a mixture of different plastic materials. Preferred laminate materials include an outer paper layer for aesthetic reasons or a metal layer further limiting the moisture permeability of the package, or a mixture thereof.

Atomiser

Conveniently, said garment revival composition is provided as a liquid and said spray mechanism may comprise an atomiser configured to break up said liquid dose into droplets and thereby facilitate creation of said fine aerosol in the form of a mist.

Conveniently, said atomiser may comprise at least one of: a swirl chamber and a lateral dispersion chamber.

Suitably, the atomiser functions to mix air with the garment revival composition.

Reservoir/Container

Suitably the internal volume of the container, i.e. the size/capacity of the reservoir, is selected from: at least 100 ml, at least 200 ml, at least 300 ml, and at least 400 ml. Suitably the volume/size of reservoir is selected from: no more than 1000 ml, no more than 800 ml, no more than 600 ml, no more than 500 ml, no more than 400 ml, and no more than 300 ml. Suitable ranges are selected from: 100 to 300 ml, and 100 to 200 ml. Other suitable ranges are selected from 200 to 600 ml, 200 to 500 ml, and 300 to 500 ml.

Spray reservoirs may be non-pressurised, manually or mechanically pre-pressurised devices. The above also to removable/refillable reservoirs.

Preferably the container has a waist region. This allows improved gripping as the bottle is rotated in use. This highly useful as the spray is applied to a garment which is hung from a frame (container) during spraying.

Spray Duration

Suitably, following actuation, the spray has a duration in the range of at least 0.4 seconds. Preferably the spray has a duration of at least 0.8 seconds. A longer duration minimises the effort by maximising coverage per actuation of a spray device. This is an important factor for products designed to be used over the full area of garments.

Preferably the spray duration is directly linked to actuation such that the spray output continues only as long as the actuator is activated (e.g. as long as a button or trigger is pressed)

Replacement Reservoir and Kits

According to a further aspect of the present invention, there is provided a replacement reservoir for a garment revival product according to the above aspect(s), the replacement reservoir being pre-filled with a volume of said garment revival composition for replenishment of said product.

The replacement reservoir may be rigid or flexible. The replacement reservoir may comprise one or more rigid walls and/or one or more flexible walls. In the case of a flexible reservoir, the reservoir may take the form of a pouch.

Suitably the replacement reservoir is elongate and has an engagement portion extending axially along a longitudinal axis of the elongate reservoir for engagement with a receiving or mating portion of the spray device. Suitably the engagement portion of the releasable reservoir comprises a threaded portion for threaded engagement with the receiving portion of the spray device. For example the replaceable reservoir may comprise an upstanding annular lip that is provided with an external screw thread for threaded engagement with a re-entrant region of the shroud that comprises an internally threaded recess.

Conveniently the replacement reservoir may be provided in a kit. Indeed, a further aspect related to the second aspect of the present invention is a kit comprising a replacement reservoir.

A suitable “refill kit” comprises one or more reservoirs. In the case of more than one reservoir, for example two, three, four, five, or more reservoirs, the contents (garment revival composition) of each reservoir may the same as or different from the other reservoirs. For example, the kit may include multiple reservoirs each comprising a composition comprising anti-malodour agents and/or different anti-wrinkle agents and/or perfumes.

The kit may contain instructions, for example instructions relating to the attachment/detachment of the reservoir to the spray mechanism/shroud.

In the case where the kit contains reservoirs with different garment refresh compositions (e.g. comprising different perfumes) the instructions may also provide guidance as to the selection of a reservoir to match with the intended use, e.g. the type of garment that is to be refreshed.

In embodiments, the kit comprises a spray device of any one of the previous aspects, and at least one, suitably two or more, replacement reservoirs.

Spray Characteristics

Suitably said spray mechanism is manually operable to discharge said composition from the product in the form of a fine mist or aerosol.

Suitably the spray mechanism comprises a nozzle and is operable to discharge a dose of said composition from the nozzle in the form of a fine aerosol.

Suitably the nozzle has a discharge orifice which is configured to produce said fine aerosol in a spray having a wide cone angle that facilitates even application of the composition to a garment.

Suitably the spray has a cone angle of at least 50 degrees, preferably at least 55 degrees, more preferably at least 60 degrees.

Suitably the spray has a cone angle of no more than 90 degrees, preferably no more than 85 degrees, more preferably no more than 80 degrees.

Suitable cone angles are selected from the range of 50 to 90 degrees, suitably 55 to 80 degrees, suitably 60 to 80 degrees.

Advantageously, said discharge orifice may be configured to produce said fine aerosol in a substantially circular spray pattern.

As discussed below, it is proposed that said composition may be provided in the form of a liquid, such that the fine aerosol produced will suitably take the form of a fine mist of droplets.

Dose

Conveniently, the garment revival composition is provided as a liquid, and said spray mechanism is operable to discharge a dose of at least 0.1 ml, preferably at least 0.2 ml, more preferably at least 0.25 ml, more preferably at least 0.3 ml, more preferably at least 0.35 ml, more preferably at least 0.35 ml, more preferably at least 0.4 ml, more preferably at least 0.45 ml, and most preferably at least 0.5 ml.

Suitably the dose is no more than 2 ml, preferably no more than 1.8 ml, preferably no more than 1.6 ml, more preferably no more than 1.5 ml, more preferably no more than 1.4 ml, more preferably no more than 1.3 ml, and most preferably no more than 1.2 ml.

Suitably the dose is between 0.1 and 2 ml of said liquid garment revival composition, preferably between 0.2 and 1.8 ml, more preferably 0.25 to 1.6 ml, more preferably 0.25 to 1.5 ml, and most preferably 0.25 to 1.2 ml.

These doses have been found to be particularly effective at achieving the desired garment revival effect (for example anti-wrinkle) without unsightly and wasteful large droplet formation.

Droplet Size

Suitably the spray comprises droplets and The particle size of the formulation when sprayed is preferably no more than 300 μm, preferably no more than 250 μm, preferably no more than 150 μm, preferably no more than 125 μm, preferably no more than 100 μm. The particle size of the formulation when sprayed is preferably at least 5 μm, preferably at least 10 μm, preferably at least 15 μm, preferably at least 20 μm, preferably at least 30 μm, preferably at least 40 μm. Suitably the spray comprises droplets having an average diameter in the range of preferably 5 to 300 μm, more preferably 10 to 250 μm, most preferably 15 to 150 μm. This size allows for homogeneous distribution and a balance between sufficient wetting of the fabric, without potential fabric damage caused by excessive dosing of certain ingredients. Droplet size may be measured on a Malvern Spraytec instrument, with the peak maximum corresponding to the average droplet size. The parameter droplet size is the volume mean diameter, D[4,3].

By providing an improved aerosol (especially a fine mist) there is more efficient use of the garment revival composition. Not only can a greater proportion of the sprayed garment revival composition be deposited on a fabric but the effectiveness of the deposited garment revival composition can be improved. In particular, the droplet dimensions in the ranges disclosed herein can achieve a comparatively even or homogenous distribution of active on the garment, which in turn optimises the garment refresh effect.

In embodiments, the spray devices can apply a significant quantity of garment revival composition to a large area of garment with even coverage and no visible wetting or marking. This is particularly advantageous for larger garments such as coats, jackets and other outer-garments.

### Garment Reviving Composition

The garment revival composition can be in any physical form, for example a solid such as a powder or granulate; or as a liquid such as an aqueous liquid. Solid forms could be mixed with water prior to spraying.

A liquid is preferred.

Fabric Setting Components

Preferably the fabric setting components are capable of setting the mechanical properties of the fabric.

The setting components may comprise mechanical re-structuring components.

Preferably the one or more fabric setting components comprises one or more setting polymers.

The one or more fabric setting components preferably comprise one or more setting polymers.

As used herein, “setting polymer” means any polymer which refers to polymer having properties of film-formation, adhesion, or coating deposited on a surface on which the polymer is applied

The setting polymer may be present at a level selected from: less than 10%, less than 7.5%, and less than 5%, by weight of the spray composition. The setting polymer may be present at a level selected from: more than 0.5%, more than 1%, and more than 1.5%, by weight of the spray composition. Suitably the setting polymer is present in the spray composition in an amount selected from the range of from about 0.5% to about 10%, preferably from about 1% to about 7.5%, more preferably from about 1.5% to about 5%, by weight of the garment revival composition.

The molecular weight of the setting polymer is preferably from 1,000 to 500,000, more preferably from 2,000 to 250,000 even more preferably from 5,000 to 200,000.

The setting polymer according to the present invention may be any water-soluble or water dispersible polymer. Preferably the polymer is a film-forming polymer or mixture of such polymers. This includes homopolymers or copolymers of natural or synthetic origin having functionality rendering the polymers water-soluble such as hydroxyl, amine, amide or carboxyl groups. The setting polymers may be cationic, anionic, non-ionic or amphoteric.

The polymers make be a single species of polymer or a mixture thereof. Preferably the setting polymer is selected from: anionic polymers, non-ionic polymers, amphoteric polymers and mixtures thereof. For all polymers herein described it is intended to cover both the acids and salts thereof.

Suitable cationic setting polymers are preferably selected from the group consisting of: quaternized acrylates or methacrylates; quaternary homopolymers or copolymers of vinylimidazole; homopolymers or copolymers comprising a quaternary dimethdiallyl ammonium chloride; cationic polysaccharides; cationic cellulose derivatives; chitosans and derivatives thereof; and mixtures thereof.

Quaternized acrylates or methacrylates are preferably selected from: copolymers comprising: a) at least one of: quaternized dialkylaminoalkyl acrylamides (e.g. Quaternized dimethyl amino propyl methacrylamide); or quaternized dialkylaminoalkyl acrylates (e.g. quaternized dimethyl aminoethyl methacrylate) and b) one or more monomers selected from the group consisting of: vinyllactams such as vinylpyrrolidone or vinylcaprolactam; acrylamides, methacrylamides which may or may not be substituted on the nitrogen by lower alkyl groups (C1-C4) (e.g. N-tertbutylacrylamide); esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; and allyl esters or methallyl esters; and mixtures thereof.

The counter ion can be either a methosulfate anion or a halide such as chloride or bromide.

Quaternary homopolymers or copolymers of vinylimidazole are preferably selected from: copolymers comprising a) a quaternized vinylimizazole and b) one or more other monomers. The other monomer may be selected from the group consisting of: vinyllactams such as vinylpyrrolidone or vinylcaprolactam such as vinylpyrrolidone/quaternized vinylimidazole (PQ-16) such as that sold as Luviquat FC-550 by BASF; acrylamides, methacrylamides which may or may not be substituted on the nitrogen by lower alkyl groups (C1-C4) (e.g. N-tertbutylacrylamide); esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; and mixtures thereof. The counter ion can be either a methosulfate anion or a halide such as chloride or bromide.

Dimethdiallyl ammonium chlorides are preferably selected from: a homopolymer or copolymer comprising a quaternary dimethdiallyl ammonium chloride and another monomer. The other monomer may be selected from the group consisting of: acrylamides, methacrylamides which may or may not be substituted on the nitrogen by lower alkyl groups (C1-C4) (e.g. N-tertbutylacrylamide); vinyllactams such as vinylpyrrolidone or vinylcaprolactam; esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; and mixtures thereof. The counter ion can be either a methosulfate anion or a halide such as chloride or bromide.

Cationic polysaccharides are preferably selected from: cationic celluloses; cationic starches; cationic glycogens; cationic chitins; cationic guar gums such as those containing trialkylammonium cationic groups, for example, such as guar hydroxypropyltrimonium chloride, which is available as N-Hance 3269 from Ashland; and mixtures thereof.

Cationic cellulose derivatives are preferably selected from: a copolymers of cellulose derivatives such as hydroxyalkylcelluloses (e.g. hydroxymethyl-, hydroxyethyl- or hydroxypropylcelluloses) grafted with a water-soluble monomer comprising a quaternary ammonium (e.g. glycidytrimethyl ammonium, methacryloyloxyethyltrimethylammonium, or a methacrylamidopropyltrimethylammonium, or dimethyldiallylammonium salt) and mixtures thereof. For example, such

as hydroxyethylcellulose dimethyldiallyammonium chloride [PQ4] sold as Celquat L200 by Akzo Nobel, or such as Quaternized hydroxyethylcellulose [PQ10] sold as UCARE JR125 by Dow Personal Care.

Chitosans and derivatives thereof are preferably selected from: chitosan and salts of chitosans. The salts can be chitosan acetate, lactate, glutamate, gluconate or pyrrolidinecarboxylate preferably with a degree of hydrolysis of at least 80%; and mixtures thereof. A suitable chitosan includes Hydagen HCMF by Cognis.

Suitable anionic setting polymers may be selected from polymers comprising groups derived from carboxylic or sulfonic acids. Copolymers containing acid units are generally used in their partially or totally neutralized form, more preferably totally neutralized. Suitable anionic setting polymer may comprise: (a) at least one monomer derived from a carboxylic acid such as acrylic acid, or methacrylic acid or crotonic acid or their salts, or C4-C8 monounsaturated polycarboxylic acids or anhydrides (e.g. maleic, furamic, itaconic acids and their anhydrides), or sulfonic acid such as vinylsulfonic, styrenesulfonic, naphthalenesulfonic, acrylalkyl sulfonic, acrylamidoalkyls ulfonic acid or their salts and (b) one or more monomers selected from the group consisting of: esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); acrylamides, methacrylamides which may or may not be substituted on the nitrogen by lower alkyl groups (C1-C4); N-alkylated acrylamide (e.g. N-tertbutylacrylamide); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; vinyllactams such as vinylpyrrolidone or vinylcapro lactam; alkyl maleimide, hydroxyalkyl maleimide (e.g. Ethyl/Ethanol Maleimide); and mixtures thereof. When present the anhydride functions of these polymers can optionally be monoesterified or monoamidated.

Alternatively the anionic setting polymer may be selected from a water-soluble polyurethane. The polyurethane is preferably dispersed in water. Suitable polyurethanes include those such as adipic acid, 1-6 hexandiol, neopentyl glycol, isophorone diisocyanate, isophorone diamine, N-(2-aminoethyl)-3-aminoethanesulphonic acid, sodium salt (also known as Polyurethane-48) such as that sold as Baycusan C1008 by Bayer; and such

as isophorone diisocyanate, dimethylol propionic acid, 4,4-isopropylidenediphenol/propylene oxide/ethylene oxide (also known as Polyurethene-14) such as that sold as a mixture under the name of DynamX H20 by Akzo Nobel; and mixtures thereof.

Alternatively the anionic setting polymer may be selected from anionic polysaccharides. Anionic polysaccharides are preferably selected from: anionic celluloses; anionic starches; anionic glycogens; anionic chitins; anioinc guar gums; and mixtures thereof.

Preferred anionic setting polymers may be selected from: copolymers derived from acrylic acid such as the acrylic acid/ethylacrylate/N-tert-butylacrylamide terpolymer such as that sold as Ultrahold 8 by BASF; Octylacrylamide/Acrylates/Butylaminoethyl/Methacrylate Copolymer such as that sold as Amphomer by Akzo Nobel, preferably Acrylates/Octylacrylamide Copolymer sold as Amphomer 4961; methacrylic acid/ester acrylate/ester methacrylate such as that sold as Balance CR by Akzo Nobel; a copolymer of butyl acrylate/methacrylic acid/methylmethacrylate; Octylacrylamide/Acrylates/Butylaminoethyl Methacrylate Copolymer such as that sold as Balance 47 by Akzo Nobel; methacrylic acid/hydroxyethylmethacrylate/various acrylate esters such as that known as Acudyne 1000 sold by Dow Chemical; acrylates/hydroxyethylmethacrylate such as that sold as Acudyne 180 by Dow Chemical; methacrylic acid/hydroxyethylmethacrylate/various acrylate esters such as that sold as Acudyne DHR by Dow Chemical; n-butyl methacrylate/methacrylic acid/ethyl acrylate copolymer such as that sold as Tilamar Fix

A-1000 by DSM; copolymers derived from crotonic acid, such as vinyl acetate/vinyl tertbutylbenzoate/crotonic acid terpolymers and the crotonic acid/vinyl acetate/vinyl neododecanoate terpolymers such as that sold as Resin 282930 by Akzo Nobel. Preferred setting polymers derived from sulfonic acid include: sodium polystyrene sulfonate sold as Flexan 130 by Ashland; sulfopolyester (also known as Polyester-5) such as that sold as Eastman AQ 48 by Eastman; sulfopolyester (also known as Polyester-5) such as that sold as Eastman AQ S38 by Eastman; sulfopolyester (also known as Polyester-5) such as that sold as Eastman AQ 55 by Eastman; and mixtures thereof.

More preferably the anionic polymer is selected from: copolymers derived from acrylic acid such as the acrylic acid/ethylacrylate/N-tert-butylacrylamide terpolymers; Octylacrylamide/Acrylates/Butylaminoethyl/Methacrylate Copolymers; methacrylic acid/ester acrylate/ester methacrylates; Octylacrylamide/Acrylates/Butylaminoethyl Methacrylate Copolymer; methacrylic acid/hydroxyethylmethacrylate/various acrylate esters;

acrylates/hydroxyethylmethacrylate; methacrylic acid/hydroxyethylmethacrylate/various acrylate esters; n-butyl methacrylate/methacrylic acid/ethyl acrylate copolymers;

copolymers derived from crotonic acid, such as vinyl acetate/vinyl tertbutylbenzoate/crotonic acid terpolymers; a copolymer of butyl acrylate/methacrylic acid/methylmethacrylate; the crotonic acid/vinyl acetate/vinyl neododecanoate terpolymers; isophorone diisocyanate, dimethylol propionic acid, 4,4-isopropylidenediphenol/propylene oxide/ethylene oxide (also known as Polyurethene-14) such as that sold as a mixture under the name of DynamX H20 by Akzo Nobeland mixtures thereof.

Non-ionic setting polymers may be natural, synthetic or mixtures thereof.

Synthetic non-ionic setting polymers are selected from: homopolymers and copolymers comprising: (a) at least one of the following main monomers: vinylpyrrolidone; vinyl esters grafted onto a polyalkylene glycol such as polyethylene glycol; acrylate esters grafted onto a polyalkylene glycol such as polyethylene glycol or acrylamide and (b) one or more other monomers such as vinyl esters (e.g. vinyl acetate or vinyl propionate, vinyl tert-butyl-benzoate); alkylacrylamine (e.g. tert-butylamino-ethyl methacrylate, dimethyl aminoethyl methacrylate); vinylcaprolactam; hydroxyalkylated acrylamide; amino alkylated acrylamide (e.g. dimethyl amino propyl methacrylamide); vinyl ether; alkyl maleimide, hydroxyalkyl maleimide (e.g. Ethyl/Ethanol Maleimide); and mixtures thereof.

Suitable natural non-ionic setting polymers are water-soluble. Preferred natural non-ionic polymers are selected from: non-ionic polysaccharides including: non-ionic cellulose, non-ionic starches, non-ionic glycogens, non-ionic chitins and non-ioinc guar gums; cellulose derivative, such as hydroxyalkylcelluloses (e.g. hydroxymethyl-, hydroxyethyl- or hydroxypropylcelluloses) and mixtures thereof.

The non-ionic setting polymers are preferably selected from vinylpyrrolidone/vinyl acetate copolymers and such as vinylpyrrolidone homopolymer.

Amphoteric setting polymers may be natural, synthetic or a mixture thereof. Suitable synthetic amphoteric setting polymers include those comprising: an acid and a base like monomer; a carboxybetaine or sulfobetaine zwitterionic monomer; and an alkylamine oxide acrylate monomer.

Suitable amphoteric setting polymers comprising acid and base monomers are preferably selected from: (a) at least one monomer containing a basic nitrogen atom such as a quaternized dialkylaminoalkyl acrylamide (e.g. Quaternized dimethyl amino propyl methacrylamide) or a quaternized dialkylaminoalkyl acrylate (e.g. quaternized dimethyl aminoethyl methacrylate) and (b) at least one acid monomer comprising one or more carboxylic or sulfonic groups such as acrylic acid, or methacrylic acid or crotonic acid or their salts, or C4-C8 monounsaturated polycarboxylic acids or anhydrides (e.g. maleic, furamic, itaconic acids and their anhydrides) and (c) one or more monomers selected from acrylamides, methacrylamides which may or may not be substituted on the nitrogen by lower alkyl groups (C1-C4) (e.g. N-tertbutylacrylamide); vinyllactams such as vinylpyrrolidone or vinylcapro lactam; esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; and mixtures thereof.

### Suitable Amphoteric Setting Polymers

comprising carboxybetaine or sulfobetaine zwitterionic monomer are preferably selected from: carboxybetaine methacrylate and sulfobetaine methacrylate. For example: (a) at least one carboxybetaine or sulfobetaine zwitterioni monomer such as carboxybetaine methacrylate and sulfobetaine methacrylate; and (b) a monomer selected from the group consisting of: acrylamides, methacrylamides which may or may not be substituted on the nitrogen by lower alkyl groups (C1-C4) (e.g. N-tertbutylacrylamide); vinyllactams such as vinylpyrrolidone or vinylcapro lactam; esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; and mixtures thereof.

Suitable amphoteric setting polymers comprising alkylamine oxide acrylate are perferably selected from: (a) an ethylamine oxide methacrylate; and (b) a monomer selected from the group consisting of: acrylamides, methacrylamides which may or may not be substituted on the nitrogen by lower alkyl groups (C1-C4) (e.g. N-tertbutylacrylamide); vinyllactams such as vinylpyrrolidone or vinylcapro lactam; esters of acrylic acid and/or methacrylic acid (e.g. C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g. poly(ethyleneglycol)acrylate); hydroxyesters acrylate (e.g. hydroxyethyl methacrylate); hydroxyalkylated acrylamide; amino alkylated acrylamide (e.g. dimethyl amino propyl methacrylamide); alkylacrylamine (e.g. tert-butylamino-ethyl methacrylate, dimethyl aminoethyl methacrylate); alkylether acrylate (e.g. 2-ethoxyethyl acrylate); monoethylenic monomer such as ethylene, styrene; vinyl esters (e.g. vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters. An example of such an amphoteric setting polymer is acrylates/ethylamine oxide methacrylate sold as Diaformer Z 731 N by Clariant; and mixtures thereof.

Preferably the setting polymer is selected from acrylate polymers, co-polymers comprising acrylate monomers, starches, celluloses, derivatives of cellulose and mixtures thereof.

Most preferably the setting polymer is selected from the group consisting of: acrylates and copolymers of two or more acrylate monomers such as: (meth)acrylic acid or one of their simple esters; octylacrylamide/acrylate/butylaminoethyl methacrylate copolymers; acrylates/hydroxyesters acrylates copolymers of butyl acrylate, methyl methacrylate, methacrylic acid, ethyl acrylate and hydroxyethyl methacrylate; polyurethane-14/AMP-acrylates copolymer blend; and mixtures thereof. This includes both the acids and salts thereof.

Anti-Wrinkle Agent

The compositions of the present invention may comprise an anti-wrinkle agent which may comprise silicone and preferably this is in an emulsion.

Silicone may be present at a level selected from: less than 10%, less than 8%, and less than 6%, by weight of the spray composition. Silicone may be present at a level selected from: more than 0.5%, more than 1%, and more than 1.5%, by weight of the spray composition. Suitably silicone is present in the spray composition in an amount selected from the range of from about 0.5% to about 10%, preferably from about 1% to about 8%, more preferably from about 0.5% to about 6%, by weight of the garment revival composition.

Silicones and their chemistry are described in, for example in The Encyclopaedia of Polymer Science, volume 11, p 765.

Silicones suitable for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, silicon hydride, carboxy, phosphate, sulphonic, phosphonate, betaine, quarternized nitrogen and mixtures thereof.

Suitable non-functionalised silicones have the general formula:

R₁—Si(R₃)₂—O—[—Si(R₃)₂—O—]ₓ—Si(R₃)₂—R₂

R₁=hydrogen, methyl, methoxy, ethoxy, hydroxy, propoxy, and aryloxy group.

R₂=hydrogen, methyl, methoxy, ethoxy, hydroxy, propoxy, and aryloxy group.

R₃=alkyl, aryl, hydroxy, or hydroxyalkyl group, and mixtures thereof

Suitable functionalised silicones may be anionic, cationic, or non-ionic functionalised silicones.

The functional group(s) on the functionalised silicones are preferably located in pendent positions on the silicone i.e. the composition comprises functionalised silicones wherein the functional group(s) are located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no functional groups located on a terminal position of the silicone.

When the silicones are branched in nature, the terminal position is deemed to be the two ends of the longest linear silicone chain. Preferably no functional group(s) are located on the terminus of the longest linear silicone chain.

Preferred functionalised silicones are those that comprise the anionic group at a mid-chain position on the silicone. Preferably the functional group(s) of the functionalised silicone are located at least five Si atoms from a terminal position on the silicone. Preferably the functional groups are distributed randomly along the silicone chain.

For best performance, it is preferred that the silicone is selected from: carboxy functionalised silicone; anionic functionalised silicone; non-functionalised silicone; and mixtures thereof. More preferably, the silicone is selected from: carboxy functionalised silicone; amino functionalised silicone; polydimethylsiloxane (PDMS) and mixtures thereof. Preferred features of each of these materials are outlined herein. Most preferably the silicone is selected from amino functionalised silicones; polydimethylsiloxane (PDMS) and mixtures thereof.

A carboxy functionalised silicone may be present as a carboxylic acid or an carbonate anion and preferably has a carboxy group content of at least 1 mol % by weight of the silicone polymer, preferably at least 2 mol %. Preferably the carboxy group(s) are located in a pendent position, more preferably located at least five Si atoms from a terminal position on the silicone. Preferably the caboxy groups are distributed randomly along the silicone chain. Examples of suitable carboxy functional silicones include FC 220 ex. Wacker Chemie and X22-3701E ex. Shin Etsu.

An amino functionalised silicone means a silicone containing at least one primary, secondary or tertiary amine group, or a quaternary ammonium group. The primary, secondary, tertiary and/or quaternary amine groups are preferably located in a pendent position, more preferably located at least five Si atoms from a terminal position on the silicone.

Preferably the amino groups are distributed randomly along the silicone chain. Examples of suitable amino functional silicones include FC222 ex. Wacker Chemie and EC218 ex. Wacker Chemie.

A polydimethylsiloxane (PDMS) polymer has the general formula:

R₁-Si(CH₃)₂—O—[—Si(CH₃)₂—O—]ₓ—(CH₃)₂—R₂

R₁=hydrogen, methyl, methoxy, ethoxy, hydroxy, propoxy, and aryloxy group.

R₂=hydrogen, methyl, methoxy, ethoxy, hydroxy, propoxy, and aryloxy group.

A suitable example of a PDMS polymer is E22 ex. Wacker Chemie.

The molecular weight of the silicone polymer is preferably from 1,000 to 500,000, more preferably from 2,000 to 250,000 even more preferably from 5,000 to 200,000.

The silicone of the present invention is in the form of an emulsion. Silicones are preferably emulsified prior to addition to the present compositions. Silicone compositions are generally supplied from manufacturers in the form of emulsions.

The average particle size of the emulsion is in the range from about 1 nm to 30 microns and preferably from about 10 nm to about 20 microns. These include micro emulsions (<100 nm, preferably 1 to 100 nm, more preferably 1 to 60 nm), and macroemulsions (about 100 nm to about 30 microns, preferably more than 150 nm and preferably less than 20 microns); and mixtures thereof. The particle size is measured as a volume mean diameter, D[4,3], this can be measured using a Malvern Mastersizer 2000 from Malvern instruments.

The particle size of the silicone emulsion will provide different fabric benefits. In one embodiment the emulsion may be in the form of a micro emulsion, providing shape rejuvenation whilst reducing staining. In an alternative embodiment the emulsion may be in the form of a macroemulsion, providing colour rejuvenation.

Aqueous Composition

The garment revival composition is suitably an aqueous garment revival composition.

Aqueous solutions are preferred for odour control. The dilute aqueous solution provides the maximum separation of anti-malodour agents (e.g. cyclodextrin molecules) on the fabric and thereby maximizes the chance that an odour molecule will interact with an anti-malodour agent.

The preferred carrier of the present invention is water. The water which is used can be distilled, deionized, or tap water. Water not only serves as the liquid carrier for the anti-malodour agent(s) such as cyclodextrins, but it also facilitates the complexation reaction between the anti-malodour agent (e.g. cyclodextrin molecules) and any malodourous molecules that are on the garment.

Suitably water is present in the garment revival composition from at least 60%, and more preferably at least 70% by weight of the garment revival composition.

Preferably the carrier further comprises an emulsifier. The emulsifier may comprise surfactants as described herein.

In embodiments, one or more of the components in the garment revival composition (e.g. anti-malodour agent, an anti-wrinkle agent, and a perfume) is or are provided as an encapsulate. Microcapsules are preferred.

Anti-Malodour Agent

Compositions of the present invention preferably comprise anti-malodour ingredient(s). Anti-malodour ingredients may be in addition to traditional free perfume ingredients.

Anti-malodour agent may be present at a level selected from: less than 20%, less than 10%, and less than 5%, by weight of the garment revival composition. Suitably anti-malodour agent is present in the garment revival composition in an amount selected from the range of from about 0.01% to about 5%, preferably from about 0.1% to about 3%, more preferably from about 0.5% to about 2%, by weight of the garment revival composition.

Any suitable anti-malodour agent may be used. Indeed, an anti-malodour effect may be achieved by any compound or product that is effective to “trap”, “absorb” or “destroy” odour molecules to thereby separate or remove odour from the garment or act as a “malodour counteractant”.

The odour control agent may be selected from the group consisting of: uncomplexed cyclodextrin; odour blockers; reactive aldehydes; flavanoids; zeolites; activated carbon; a mixture of zinc ricinoleate or a solution thereof and a substituted monocyclic organic compound; and mixtures thereof.

As noted above, a suitable anti-malodour agent is cyclodextrin, suitably water soluble uncomplexed cyclodextrin. Suitably cyclodextrin is present at a level selected from 0.01% to 5%, 0.1% to 4%, and 0.5% to 2% by weight of the garment revival composition.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings.

Preferably, the cyclodextrins are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH2-CH(OH)—CH3 or a —CH2CH2-OH group; branched cyclodextrins such as maltose-bonded cyclodextrins; cationic cyclodextrins such as those containing 2-hydroxy-3-(dimethylamino)propyl ether, wherein R is CH2-CH(OH)—CH2-N(CH3)2 which is cationic at low pH; quaternary ammonium, e.g., 2-hydroxy-3-(trimethylammonio)propyl ether chloride groups, wherein R is CH2-CH(OH)—CH2-N+(CH3)3Cl—; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrinse

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odour control performance. Solubilized, water-soluble cyclodextrin can exhibit more efficient odour control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar U.S.A., Inc. and Wacker Chemicals (U.S.A.), Inc.

In embodiments mixtures of cyclodextrins are used.

“Odour blockers” can be used as an anti-malodour agent to mitigate the effects of malodours. Non-limiting examples of odour blockers include 4-cyclohexyl-4-methyl-2-pentanone, 4-ethylcyclohexyl methyl ketone, 4-isopropylcyclohexyl methyl ketone, cyclohexyl methyl ketone, 3-methylcyclohexyl methyl ketone, 4-tert.-butylcyclohexyl methyl ketone, 2-methyl-4-tert.butylcyclohexyl methyl ketone, 2-methyl-5-isopropylcyclohexyl methyl ketone, 4-methylcyclohexyl isopropyl ketone, 4-methylcyclohexyl secbutyl ketone, 4-methylcyclohexyl isobutyl ketone, 2,4-dimethylcyclohexyl methyl ketone, 2,3-dimethylcyclohexyl methyl ketone, 2,2-dimethylcyclohexyl methyl ketone, 3,3-dimethylcyclohexyl methyl ketone, 4,4-dimethylcyclohexyl methyl ketone, 3,3,5-trimethylcyclohexyl methyl ketone, 2,2,6-trimethylcyclohexyl methyl ketone, 1-cyclohexyl-1-ethyl formate, 1-cyclohexyl-1-ethyl acetate, 1-cyclohexyl-1-ethyl propionate, 1-cyclohexyl-1-ethyl isobutyrate, 1-cyclohexyl-1-ethyl n-butyrate, 1-cyclohexyl-1-propyl acetate, 1-cyclohexyl-1-propyl n-butyrate, 1-cyclohexyl-2-methyl-1-propyl acetate, 2-cyclohexyl-2-propyl acetate, 2-cyclohexyl-2-propyl propionate, 2-cyc10hexyl-2-propyl isobutyrate, 2-cyc10hexyl-2-propyl nbutyrate, 5,5-dimethyl-1,3-cyclohexanedione (dimedone), 2,2-dimethyl-1,3-dioxane-4,6-dione (Meldrum's acid), spiro-[4.5]-6,1 0-dioxa-7,9-dioxodecane, spiro-[5.5]-1,5-dioxa-2,4-dioxoundecane, 2,2-hydroxymethyl-1,3-dioxane-4,6-dione and 1,3-cyclohexadione. Odour blockers are disclosed in more detail in U.S. Pat. Nos. 4,009,253; 4,187,251; 4,719,105; 5,441,727; and 5,861,371, incorporated herein by reference.

Reactive aldehydes can be used as anti-malodour agent to mitigate the effects of malodours. Examples of suitable reactive aldehydes include Class I aldehydes and Class II aldehydes. Examples of Class I aldehydes include anisic aldehyde, o-allyl-vanillin, benzaldehyde, cuminic aldehyde, ethylaubepin, ethyl-vanillin, heliotropin, tolyl aldehyde, and vanillin. Examples of Class II aldehydes include 3-(4′-tert.butylphenyl)propanal, 2-methyl-3-(4′-tertbutylphenyl)propanal, 2-methyl-3-(4′-isopropylphenyl)propanal, 2,2-dimethyl-3-(4-ethylphenyl)propanal, cinnamic aldehyde, a-amyl-cinnamic aldehyde, and a-hexyl-cinnamic aldehyde. These reactive aldehydes are described in more detail in U.S. Pat. No. 5,676,163. Reactive aldehydes, when used, can include a combination of at least two aldehydes, with one aldehyde being selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and the second aldehyde being selected from aldehydes possessing an unsaturation alpha to the aldehyde function conjugated with an aromatic ring, and aldehydes in which the aldehyde group is on an aromatic ring. This combination of at least two aldehydes is described in more detail in WO 00/49120. As used herein, the term “reactive aldehydes” further encompasses deodourizing materials that are the reaction products of (i) an aldehyde with an alcohol, (ii) a ketone with an alcohol, or (iii) an aldehyde with the same or different aldehydes.

Such deodourizing materials can be: (a) an acetal or hemiacetal produced by means of reacting an aldehyde with a carbinol; (b) a ketal or hemiketal produced by means of reacting a ketone with a carbinol; (c) a cyclic triacetal or a mixed cyclic triacetal of at least two aldehydes, or a mixture of any of these acetals, hemiacetals, ketals, hemiketals, or cyclic triacetals. These deodorizing perfume materials are described in more detail in WO 01/07095 incorporated herein by reference.

Flavanoids can also be used as anti-malodour agent. Flavanoids are compounds based on the C6-C3-C6 flavan skeleton. Flavanoids can be found in typical essential oils. Such oils include essential oil extracted by dry distillation from needle leaf trees and grasses such as cedar, Japanese cypress, eucalyptus, Japanese red pine, dandelion, low striped bamboo and cranesbill and can contain terpenic material such as alpha-pinene, beta-pinene, myrcene, phencone and camphene. Also included are extracts from tea leaf. Descriptions of such materials can be found in JP 02284997 and JP 04030855 incorporated herein by reference.

Metallic salts can also be used as anti-malodour agents for malodour control benefits. Examples include metal salts of fatty acids. Ricinoleic acid is a preferred fatty acid. Zinc salt is a preferred metal salt. The zinc salt of ricinoleic acid is especially preferred. A commercially available product is TEGO Sorb A30 ex Evonik. Further details of suitable metallic salts is provided below. Zeolites can be used as anti-malodour agent. A useful class of zeolites is characterized as “intermediate” silicate/aluminate zeolites. The intermediate zeolites are characterized by SiO₂/AlO₂ molar ratios of less than about 10. Preferably the molar ratio of SiO₂/AlO₂ ranges from about 2 to about 10. The intermediate zeolites can have an advantage over the “high” zeolites. The intermediate zeolites have a higher affinity for amine-type odours, they are more weight efficient for odour absorption because they have a larger surface area, and they are more moisture tolerant and retain more of their odour absorbing capacity in water than the high zeolites. A wide variety of intermediate zeolites suitable for use herein are commercially available as Valfor® CP301-68, Valfor® 300-63, Valfor® CP300-35, and Valfor® CP300-56, available from PQ Corporation, and the CBV100® series of zeolites from Conteka. Zeolite materials marketed under the trade name Abscents® and Smellrite®, available from The Union Carbide Corporation and UOP are also preferred. Such materials are preferred over the intermediate zeolites for control of sulfur-containing odours, e.g., thiols, mercaptans. Suitably the zeolite material has a particle size of less than about 10 microns and is present in the garment revival composition at a level of less than about 1% by weight of the garment revival composition.

Activated carbon is another suitable anti-malodour agent. Suitable carbon material is a known absorbent for organic molecules and/or for air purification purposes. Often, such carbon material is referred to as “activated” carbon or “activated” charcoal. Such carbon is available from commercial sources under such trade names as; Calgon-Type CPG®; Type PCB®; Type SGL®; Type CAL®; and Type OL®. Suitably the activated carbon preferably has a particle size of less than about 10 microns and is present in the garment revival composition at a level of less than about 1% by weight of the garment revival composition.

Exemplar anti-malodour agents are as follows.

ODOBAN™ is manufactured and distributed by Clean Central Corp. of Warner Robins, Ga. Its active ingredient is alkyl (C14 50%, C12 40% and C16 10%) dimethyl benzyl ammonium chloride which is an antibacterial quaternary ammonium compound. The alkyl dimethyl benzyl ammonium chloride is in a solution with water and isopropanol. Another product by Clean Control Corp. is BIOODOUR CONTROL™ which includes water, bacterial spores, alkylphenol ethoxylate and propylene glycol.

ZEOCRYSTAL FRESH AIR MIST™ is manufactured and distributed by Zeo Crystal Corp. (a/k/a American Zeolite Corporation) of Crestwood, Ill. The liquid comprises chlorites, oxygen, sodium, carbonates and citrus extract, and may comprise zeolite.

The odour control agent may comprise a “malodour counteractant” as described in US2005/0113282A1 by which is hereby incorporated by reference. In particular this malodour counteractant may comprise a mixture of zinc ricinoleate or a solution thereof and a substituted monocyclic organic compound as described at page 2, paragraph 17 whereby the substituted monocyclic organic compound is in the alternative or in combination one or more of:

1-cyclohexylethan-1-yl butyrate;
1-cyclohexylethan-1-yl acetate;
1-cyclohexylethan-1-ol;
1-(4′-methylethyl) cyclohexylethan-1-yl propionate; and
2′-hydroxy-1′-ethyl(2-phenoxy)acetate.

Synergistic combinations of malodour counteractants as disclosed at paragraphs 38-49 are suitable, for example, the compositions comprising:

(i) from about 10 to about 90 parts by weight of at least one substituted monocyclic organic compound-containing material which is:
(a) 1-cyclohexylethan-1-yl butyrate having the structure:

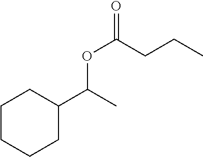

(b) 1-cyclohexylethan-1-yl acetate having the structure:

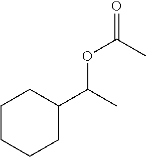

(c) 1-cyclohexylethan-1-ol having the structure:

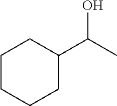

(d) 1-(4′-methylethyl)cyclohexylethan-1-yl propionate having the structure:

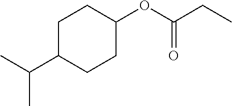

and
(e) 2′-hydroxy-1′-ethyl(2-phenoxy)acetate having the structure:

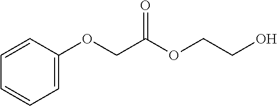 [SMILES: O=C(COc1ccccc1)OCCO]

and (ii) from about 90 to about 10 parts by weight of a zinc ricinoleate-containing composition which is zinc ricinoleate and/or solutions of zinc ricinoleate containing greater than about 30% by weight of zinc ricinoleate. Preferably, the aforementioned zinc ricinoleate-containing compositions are mixtures of about 50% by weight of zinc ricinoleate and about 50% by weight of at least one 1-hydroxy-2-ethoxyethyl ether of a More specifically, a preferred composition useful in combination with the zinc ricinoleate component is a mixture of:
(A) 1-cyclohexylethan-1-yl butyrate;
(B) 1-cyclohexylethan-1-yl acetate; and
(C) 1-(4′-methylethyl)cyclohexylethan-1-yl propionate.

More preferably, the weight ratio of components of the immediately-aforementioned zinc riconoleate-containing mixture is one where the zinc ricinoleate-containing composition: 1-cyclohexylethan-1-yl butyrate: 1-cyclohexylethan-1-yl acetate: 1-(4′-methylethyl)-cyclohexylethan-1-yl propionate is about 2:1:1:1.

Another preferred composition useful in combination with the zinc ricinoleate component or solution is a mixture of:

(A) 1-cyclohexylethan-1-yl acetate; and
(B) 1-(4′-methylethyl)cyclohexylethan-1-yl propionate.

More preferably, the weight ratio of components of the immediately-aforementioned zinc riconoleate mixture is one where the zinc ricinoleate-containing composition: 1-cyclohexylethan-1-yl acetate: 1-(4′-methylethyl)cyclohexylethan-1-yl propionate is about 3:1:1.

The anti-malodour materials of the present invention may be ‘free’ in the composition or they may be encapsulated. Suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred encapsulating materials are aminoplasts, such as melamine formaldehyde or urea formaldehyde. The microcapsules of the present invention can be friable microcapsules and/or moisture activated microcapsules. By friable, it is meant that the perfume microcapsule will rupture when a force is exerted. By moisture activated, it is meant that the perfume is released in the presence of water.

To the extent any material described herein as an odour control agent might also be classified as another component described herein, for purposes of the present invention, such material shall be classified as an odour control agent.

Free Perfume

The compositions of the present invention preferably comprise free perfume.

Free perfume may be present at a level selected from: less than 10%, less than 8%, and less than 5%, by weight of the spray composition. Free perfume may be present at a level selected from: more than 0.0001%, more than 0.001%, and more than 0.01%, by weight of the spray composition. Suitably free perfume is present in the spray composition in an amount selected from the range of from about 0.0001% to about 10%, preferably from about 0.001% to about 8%, more preferably from about 0.01% to about 5%, by weight of the garment revival composition.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

A wide variety of chemicals are known for perfume use including materials such as aldehydes, ketones, esters and the like. More commonly, naturally occurring plant and animal oils and exudates comprising complex mixtures of various chemical components are known for use as perfume, and such materials can be used herein. Typical perfumes can comprise e.g. woody/earthy bases containing exotic materials such as sandalwood oil, civet and patchouli oil. The perfume also can be of a light floral fragrance e.g. rose or violet extract. Further the perfume can be formulated to provide desirable fruity odours e.g. lime, limon or orange.

Particular examples of useful perfume components and compositions are anetole, benzaldehyde, benzyl acetate, benzyl alcohol, benzyl formate, iso-bornyl acetate, camphene, cis-citral (neral), citronellal, citronellol, citronellyl acetate, paracymene, decanal, dihydrolinalool, dihydromyrcenol, dimethyl phenyl carbinol, eucalyptol, geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone, myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, vertenex (para-tertiary-butyl cyclohexyl acetate), amyl cinnamic aldehyde, iso-amyl salicylate, beta-caryophyllene, cedrene, cinnamic alcohol, couramin, dimethyl benzyl carbinyl acetate, ethyl vanillin, eugenol, iso-eugenol, flor acetate, heliotrophine, 3-cis-hexenyl salicylate, hexyl salicylate, lilial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, veratraldehyde, alpha-cedrene, beta-cedrene, C15H24sesquiterpenes, benzophenone, benzyl salicylate, ethylene brassylate, galaxolide (1,3,4,6,7,8-hexahydro-4,6,6,7,8,8,-hexamethyl-cyclo-penta-gamma-2-benzopyran), hexyl cinnamic aldehyde, lyral (4-(4-hydroxy-4-methyl pentyl)-3-cyclohexene-10-carboxaldehyde), methyl cedrylone, methyl dihydro jasmonate, methyl-beta-naphthyl ketone, musk ambrette, musk idanone, musk ketone, musk tibetine, musk xylol, aurantiol and phenylethyl phenyl acetate.

The free perfume compositions of the present compositions comprise blooming perfume ingredients. Blooming perfume components are defined by a boiling point less than 250° C. and a Log P or greater than 2.5. Preferably the free perfume compositions of the present invention comprise at least 10 w.t. % blooming perfume ingredients, more preferably at least 20 w.t. % blooming perfume ingredients, most preferably at least 25 w.t. % blooming perfume ingredients. Preferably the free perfume compositions of the present comprise less than 58 w.t. % blooming perfume ingredients, more preferably less than 50 w.t. % blooming perfume ingredients, most preferably less than 45 w.t. % blooming perfume ingredients. Suitably the free perfume compositions of the present compositions comprise 10 to 58 w.t. % blooming perfume ingredients, preferably 20 to 50 w.t. % blooming perfume ingredients, more preferably 25 to 45 w.t. % blooming perfume ingredients,

Examples of suitable blooming perfume ingredient include: Allo-ocimene, Allyl heptanoate, trans-Anethole, Benzyl butyrate, Camphene, Carvacrol, cis-3-Hexenyl tiglate, Citronellol, Citronellyl acetate, Citronellyl nitrile, Cyclohexylethyl acetate, Decyl Aldehyde (Capraldehyde), Dihydromyrcenol, Dihydromyrcenyl acetate, 3,7-Dimethyl-1-octanol, Fenchyl Acetate, Geranyl acetate, Geranyl formate, Geranyl nitrile, cis-3-Hexenyl isobutyrate, Hexyl Neopentanoate, Hexyl tiglate, alpha-Ionone, Isobornyl acetate, Isobutyl benzoate, Isononyl acetate, Isononyl alcohol, Isopulegyl acetate, Lauraldehyde, Linalyl acetate, Lorysia, D-limonene, Lymolene, (−)-L-Menthyl acetate, Methyl Chavicol (Estragole), Methyl n-nonly acetaldehyde, Methyl octyl acetaldehyde, Beta-Myrcene, Neryl acetate, Nonyl acetate, Nonaldehyde, Para-Cymene, alpha-Pinene, beta-Pinene, alpha-Terpinene, gamma-Terpinene, Terpineolene, alpha-Terpinyl acetate, Tetrahydrolinalool, Tetrahydromyrcenol, 2-Undecenal, Verdox (o-t-Butylcyclohexyl acetate), and Vertenex(4-tert.Butylcyclohexyl acetate).

Other useful perfume ingredients include substantive perfume components. Substantive perfume components are defined by a boiling point greater than 250° C. and a Log P greater than 2.5. Preferably the free perfume composition further comprises substantive perfume ingredients.

Boiling point is measured at standard pressure (760 mm Hg). Preferably a perfume composition will comprise a mixture of blooming and substantive perfume components. The perfume composition may comprise other perfume components.

The log P of many perfume ingredients have been reported; for example, the Pomona92 database, available from Daylight Chemical Information Systems, Inc. (Daylight CIS), Irvine, Calif., contains many, along with citations to the original literature. However, the log P values are most conveniently calculated by the “CLOGP” program, also available from Daylight CIS. This program also lists experimental log P values when they are available in the Pomona92 database. The “calculated log p” (Clog P) is determined by the fragment approach of Hansch and Leo (cf., A Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The Clog P values, which are the most reliable and widely used estimates for this physicochemical property, are used instead of the experimental log P values in the selection of perfume ingredients herein.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The free perfume of the present invention is in the form of an emulsion. The particle size of the emulsion can be in the range from about 1 nm to 30 microns and preferably from about 100 nm to about 20 microns. The particle size is measured as a volume mean diameter, D[4,3], this can be measured using a Malvern Mastersizer 2000 from Malvern instruments.

Without wishing to be bound by theory, it is believed that the free perfumes of this emulsion particle size will interact with the silicone emulsion to provide improved perfume longevity on the items being sprayed.

Free oil perfume forms an emulsion in the present compositions. The emulsions may be formed outside of the compositon or in situ. When formed in situ, at leats one emulsifier is preferably added with the free oil perfume to stabilise the emulsion. Preferably the emulsifier is anionic or non-ionic. Examples suitable anionic emulsifiers for the free oil perfume are alkylarylsulphonates, e.g., sodium dodecylbenzene sulphonate, alkyl sulphates e.g., sodium lauryl sulphate, alkyl ether sulphates, e.g., sodium lauryl ether sulphate nEO, where n is from 1 to 20 alkylphenol ether sulphates, e.g., octylphenol ether sulphate nEO where n is from 1 to 20, and sulphosuccinates, e.g., sodium dioctylsulphosuccinate. Examples of suitable nonionic surfactants used as emulsifiers for the free oil perfume are alkylphenol ethoxylates, e.g., nonylphenol ethoxylate nEO, where n is from 1 to 50, alcohol ethoxylates, e.g., lauryl alcohol nEO, where n is from 1 to 50, ester ethoxylates, e.g., polyoxyethylene monostearate where the number of oxyethylene units is from 1 to 30 and PEG-40 hydrogenated castor oil.

Other Composition Features

Other optional ingredients may be present in the aqueous spray compositions of the present invention. For example the aqueous spray compositions may further comprise: colourants/dyes, preservatives, viscosity control agents, microcapsules comprising benefit agents, structurants/dispersants, solvents, antifoams for processing aid etc.

Suitably the garment revival composition is substantially free, suitably essential free of, suitably free of, any material that would soil or stain garment fabric under usage conditions.

### Garments

The garment can be any article of clothing. In particular, garments may comprise those which contain signature creases. Such signature creases include e.g. trouser leg creases and shirt sleeve creases, wherein such creases are usually obtained by hot ironing following a main wash. Signature creases signal to an observer or wearer that the garment has been ironed and therefore it is clean or just-washed.

The applicant has observed that the creasing, misshaping, malodours and odour-causing agents, and indeed the accumulation patterns of such creases, malodours and odour-causing agents is characteristic of garments and is different from other materials such as hard surfaces and household upholstery. In the same way as the washing of garments benefits from a cleaning formulation and cleaning process that is tailored to garments, in contrast to a differently tailored formulation and process for e.g. upholstery, so the garment revival composition (and its associated spray device) may be tailored to garment revival.

As used herein “garment” means clothes/clothing. It does not include materials or fabrics that are part of household furnishings, carpets, curtains and the like. And so mention herein of “fabric” means, unless indicated to the contrary, “garment fabric”.

Each one of the proposals and associated aspects and optional features is combinable with any one or more of the other proposals and its/their associated aspects and optional features.

So that the invention may be more readily understood, and so that further features thereof may be appreciated, embodiments of the invention will now be described by way of example with reference to the accompanying drawings in which:

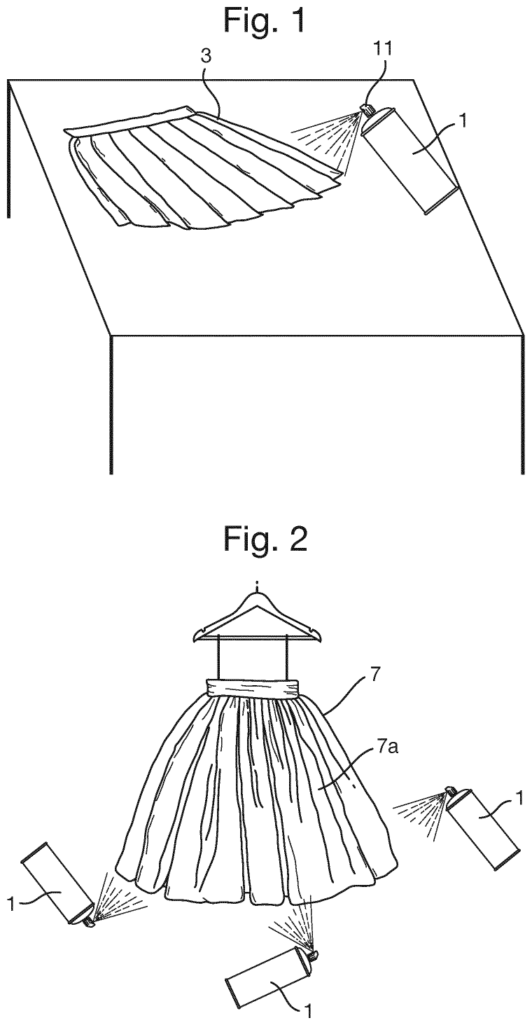

FIG. 1 is a schematic view of a fabric revival product in use, spraying a pleated skirt for ambient pressing; and

FIG. 2 is a schematic view of a fabric revival product in use, with several spray positions shown, spraying a gathered skirt with uncreased folds to add structure and volume

Referring to FIG. 1, in exemplary embodiment of a fabric revival product in accordance with the invention, is shown in use. A hand-held spray device comprises a spray device 1 spraying a pleated skirt 3 with pleats (crease lines) 3a shown supported on a table top 5.

The spray device comprises an outer container containing the composition and a pressurizing agent, wherein the composition is segregated from the pressurizing agent by containment by hermetical sealing in a flexible pouch. This which maintains complete formulation integrity so that only pure (i.e. excludes pressurising agent) composition is dispensed. This may be known as a ‘bag-in-can’ (or BOV, bag-on-valve technology).

The outer container is preferably rigid sufficient to contain the pressurised agent. The pressurised agent is preferably a gas such as air or nitrogen. The flexible pouch is a laminate pouch. The flexible pouch is fluidly connected to a nozzle. With such a spray device, compressed gas is charged into the outer container, and an aerosol valve with the bag attached is crimped onto the container. The formulation is forced through the aerosol valve stem to fill the bag and an actuator 11 put in place.

One advantage is with such a spray device is that it can provide 360-degree dispensing for spraying of an article. This is especially useful for the method of spraying detailed parts e.g. pleats of differing direction in FIG. 1 and for imparting volume, structural features as shown in FIG. 2.

In FIG. 1, the garment is supported on the table, and sprayed by the user (not shown for clarity) pressing the actuator 11. The garment is then pressed by hand, paying attention to the crease lines. It may then hung or left on the table to dry.

Turning now to consider FIG. 2 a further garment is shown, being a gathered skirt 7 with uncreased folds 7a. The signature ‘look’ of this garment is its volume. To treat this garment, it is hung from a frame e.g. coat hanger 9 and sprayed using the spray device 1 in multiple directions. It may then hung to dry.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A garment revival system using a garment revival delivery device comprising:
i. a garment revival composition containing a silicone emulsion and one or more fabric setting components and
ii. a garment revival delivery device, the device configured to be manually operable to produce a spray of the composition;
wherein the garment revival delivery device is configured to provide 360-degree dispensing.

2. The garment revival system according to claim 1 wherein the one or more fabric setting components comprise one or more setting polymers.

3. The garment revival system according to claim 1 wherein the delivery device comprises a plastic.

4. The garment revival system according to claim 1 wherein the delivery device comprises comprises a biodegradable plastic material.

5. The garment revival system according to claim 1 wherein the delivery device comprises comprises a bioplastic material.

6. The garment revival system according to claim 1 wherein the garment revival composition further comprises an anti-wrinkle agent.

7. The garment revival system according to claim 1 wherein the garment revival composition is an aqueous composition.

8. The garment revival system or spray according to claim 1 wherein the garment revival composition further comprises an anti-malodour agent.

9. The garment revival system or spray according to claim 1 wherein the garment revival composition further comprises a perfume.

10. (canceled)

11. A garment revival method comprising:
spraying a garment by manually operating a hand-held spray device so as to direct a spray output of the device onto a garment,
wherein the spray output comprises a garment revival composition comprising one or more fabric setting components; and
wherein the hand-held spray device is configured to provide 360-degree dispensing.

12. The garment revival method according to claim 11 comprising the step of suspending the garment from a frame and spraying the suspended garment.

13. The garment revival method according to claim 11 comprising the step of spraying non-creased, curved folds to impart volume to a garment.

14. (canceled)

15. (canceled)
